(19) United States
(12) Patent Application Publication
(10) Pub. No.: US 2004/0083304 A1
(43) Pub. Date: Apr. 29, 2004

(54) Communication terminal and communication system

(76) Inventor: Izumi Usuki, Katano-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/687,739

(22) Filed: Oct. 20, 2003

(30) Foreign Application Priority Data
Oct. 21, 2002 (JP) 2002-305426

(51) Int. Cl. G06F 15/173

(52) U.S. Cl. 709/238

(57) ABSTRACT

A part or all of nodes, which form a network where information is propagated through data transfers between the nodes, are capable of managing propagation history (data source and data destination) information in their own node for data relayed by each node, and restoring all of the data propagation history by combining a part or all of the history information dispersed in the nodes.

### BACKGROUND OF THE INVENTION

(1) Field of the Invention

The present invention relates to communication management technology in a network system, especially relates to methods to acquire and to utilize propagation history information about content and the like that are transmitted and received in a network such as the Internet.

(2) Description of the Related Art

In an information distribution service system that distributes content and information, which require copy right protection, through a network composed of a plural number of communication terminal apparatuses (hereinafter referred to as a “node”), it is important to grasp propagation history of such content and the like for right management of each copy right holder. As an example of a method to manage such propagation history of content and the like, there is an apparatus that can trace a source of an unauthorized copy by using content DNA (for example, see the Japanese Laid Open Patent Number 2001-23297). The “content DNA” referred here indicates distribution management information that shows distribution history of the concerned content, which is stored in the content itself or in an apparatus storing the content.

However, since such history information is processed into information having a DNA feature and memorized in the above mentioned apparatus, whether content's copy history is traceable or not is depended on presence of a difference in the content DNA between adjoining generations. If the content DNA in one of the generations is missing (i.e. the content DNA cannot be acquired because the node concerned is switched off, or due to something else), it becomes impossible to trace the said copy history, which is a problem. Although it is possible have all of the nodes be connected to the network all the time just for making the said copy history traceable, this can not be considered as a realistic solution. Therefore, it seems such a conventional system as stated above would not be effectively functioned.

### SUMMARY OF THE INVENTION

In the light of the above issues and problems, the present invention aims at providing a communication terminal and the like that do not require a server, and is capable of tracking propagation of content even when a node is disconnected in a network.

In order to achieve the above objective, the communication terminal according to the present invention is a communication terminal that communicates with a plural number of other communication terminals in a network, comprising: a data transmitting unit operable to transmit data to a first communication terminal; a history information memorizing unit operable to memorize, per data for transmission, information which includes information specifying the first communication terminal as propagation history information that shows a propagation route of the concerned data; a propagation information receiving unit operable to receive, from the first communication terminal, propagation information that shows that data for transmission is transmitted from the first communication terminal to a second communication terminal; and a history information updating unit operable to add the received propagation information to corresponding propagation history information memorized in the history information memorizing unit.

Moreover, for accomplishing the above objective, the communication terminal according to the present invention is the communication terminal comprising a data receiving unit operable to receive data from a third communication terminal; an additionally memorizing unit operable to additionally memorize information, which includes information specifying the third communication terminal, in the history information memorizing unit per data for receipt, as propagation history information that shows a propagation route of the concerned data; a second history information updating unit operable to update, when data for receipt is transmitted to a fourth communication terminal from the concerned communication terminal, the propagation history information, which is additionally memorized in the history information memorizing unit, by using information specifying the fourth communication terminal; and a propagation information transmitting unit operable to transmit propagation information, which shows the said data is transmitted to the forth communication terminal, to the third communication terminal.

In this way, it is possible to realize a communication terminal that can trace propagation of content in a network without requiring a server, since information that shows the propagation is shared between preceding and subsequent communication terminals every time data is propagated.

Furthermore, for achieving the above objective, a communication system according to the present invention is a communication system comprising at least three communication terminals connected to a network, wherein a first communication terminal includes: a first data transmitting unit operable to transmit data to a second communication terminal; a first history information memorizing unit operable to memorize information, which includes information specifying the second communication terminal, per data for transmission, as propagation history information that shows a propagation route of the concerned data; a first propagation information receiving unit operable to receive propagation information that shows data for transmission is transmitted from the second communication terminal to a third communication terminal; and a first history information updating unit operable to add the received propagation information to the propagation history information memorized in the first history information memorizing unit, the second communication terminal includes: a second data receiving unit operable to receive data from the first communication terminal; a second history information memorizing unit operable to memorize information, which includes information specifying the first communication terminal per data for receipt, as propagation history information that shows a propagation route of the concerned data; a second history information updating unit operable to update, when data for receipt is transmitted to the third communication terminal from the concerned communication terminal, the propagation history information, which is memorized in the second history information memorizing unit, by using information specifying the third communication terminal; and a second propagation information transmitting unit operable to transmit propagation information, which shows data for transmission is transmitted to the third communication terminal, to the first communication terminal.

In this way, it is possible to realize a communication system that can trace propagation of content in a network without requiring a server, since information that shows the propagation is shared between preceding and subsequent communication terminals every time data is propagated.

Also, in order to achieve the above objective, the present invention may be embodied as a communication method having characteristic means of the above communication terminal as steps, or as a program containing all of those steps. Then, the program may be stored in a ROM equipped with the communication terminal as well as being distributed through a transmission media such as a communication network or a recording media like a CD-ROM.

Although the present invention is described with following embodiments and attached drawings, it is not intended that the present invention is only limited to these.

### BRIEF DESCRIPTION OF THE DRAWINGS

These and other subjects, advantages and features of the invention will become apparent from the following description thereof taken in conjunction with the accompanying drawings that illustrate a specific embodiment of the invention. In the Drawings:

FIG. 1 is an overview diagram of a propagation history decentralized management system according to a first embodiment.

FIG. 2 is an example of a propagation history information file that is generated and updated in the propagation history decentralized management system in FIG. 1.

FIG. 3 is an overview diagram to show a more generalized form of the propagation history decentralized management system in FIG. 1.

FIG. 4 is a block diagram to show functional configurations of a source node and a destination node in the propagation history decentralized management system according to the first embodiment.

FIG. 5A is an example to show how the propagation history information file is written in a nodeC after a transfer in FIG. 4 is executed.

FIG. 5B is an example to show how the propagation history information file is written in a nodeF after the transfer in FIG. 4 is executed.

FIG. 6A is a flow chart to show a flow of history information updating processes for updating details of the propagation history information file in the source node for a case the content and the like are transmitted to other node.

FIG. 6B is a flow chart to show a flow of history information updating processes for updating details of the propagation history information file in the destination node for a case the content and the like are received from other node.

FIG. 7 is a flow chart to show a flow of history information updating processes in a node that received a history update instruction notice.

FIG. 8 is a flow chart to show a flow of history information updating processes in the source node for a case it transmitted the content and the like to other node according to a modified embodiment of the first embodiment.

FIG. 9 is an overview diagram of a propagation history decentralized management system according to a second embodiment.

FIG. 10 is a block diagram to show functional configurations of a source node and a destination node in the propagation history decentralized management system according to the second embodiment.

FIG. 11 is a flow chart to show a flow of processes for a case a destination node receives a control command, “Delete certain content” from a source node according to the second embodiment.

FIG. 12 is a flow chart to show a flow of processes for a case the destination node receives a control command according to a modified embodiment 1 of the second embodiment.

FIG. 13 is a flow chart to show a flow of control command transfer retrying processes in FIG. 12.

FIG. 14 is a flow chart to show a flow of processes for a case the destination node receives a control command according to a modified embodiment 2 of the second embodiment.

FIG. 15 is a flow chart to show a flow of control command transfer following processes in FIG. 14.

FIG. 16 is a conceptual diagram of a propagation history decentralized management system structured in a home electric appliance according to a third embodiment.

FIG. 17 is a block diagram of functional configurations of a source node and a destination node in the propagation history decentralized management system according to the third embodiment.

FIG. 18 is a flow chart to show a flow of processes in the propagation history decentralized management system in FIG. 17.

### DESCRIPTION OF THE PREFERRED EMBODIMENT(S)

The following describes the present invention by using several embodiments and drawings.

(First Embodiment)

This embodiment describes methods to generate and to update a propagation history information file that shows a propagation process as content, information and the like (hereinafter referred to as “content and the like”) of a moving image, sound, a photograph, and the like are propagated into the nodes through the network. The propagation history information file mentioned here is assumed to be managed per content in each node.

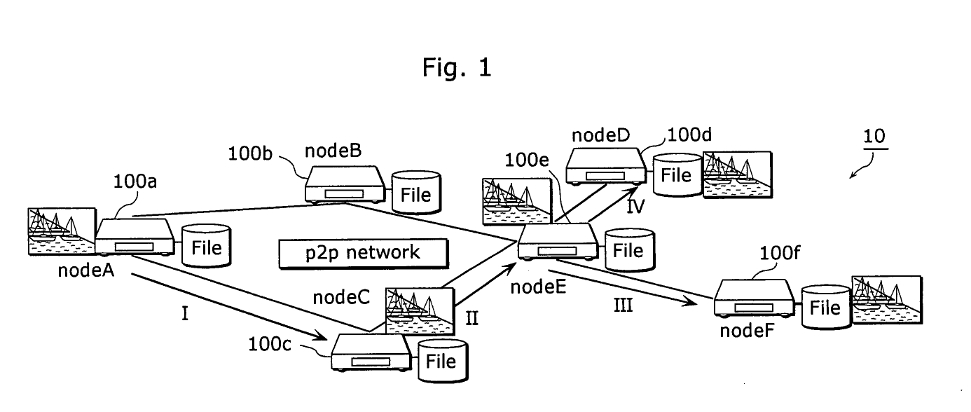

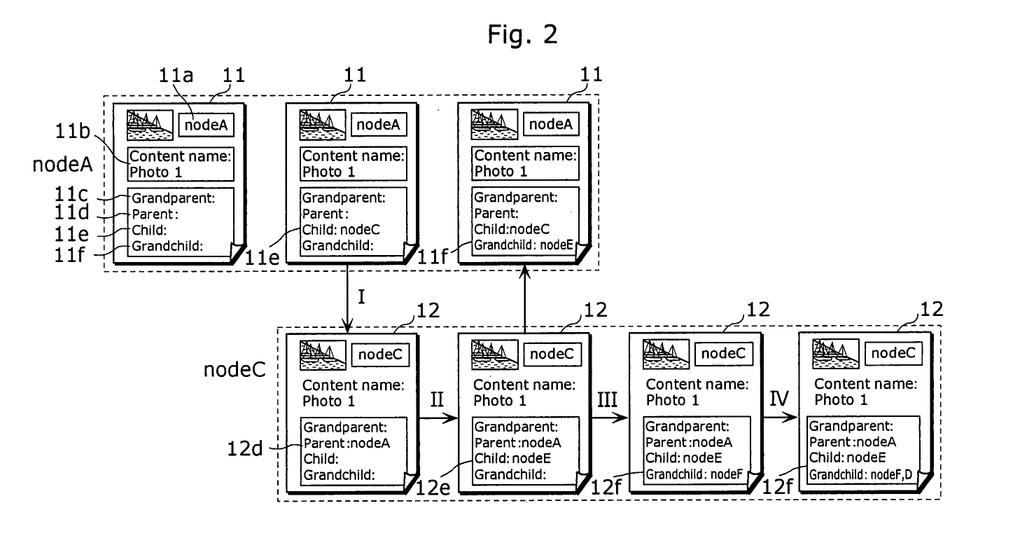

FIG. 1 is an overview diagram of a propagation history decentralized management system 10 according to the present embodiment. And, FIG. 2 is an example of a propagation history information file generated and updated in the above mentioned propagation history decentralized management system 10.

The propagation history decentralized management system 10 shown in FIG. 1 is, for example, constructed in a P2P network, and contains a node 100a (nodeA) ˜ a node 100f (nodeF). The embodiment in FIG. 1 assumes a case that content of “Photo 1” is sequentially transferred in an order of nodeA→nodeC→nodeE→nodeF and nodeD. In this case, as its initial state, in a propagation history information file 11 regarding the content of “Photo 1” stored in the node A, “nodeA” is written in its own node field 11a and the “Photo 1” is written in a content name field 11b. The “own node field” mentioned here is a domain that stores information indicating a node where the propagation history information file itself is stored (hereinafter referred to as a “self-node”).

There are nothing written in a grandparent field 11c˜a grandchild field 11f. The “grandparent field” mentioned here indicates a domain that stores information showing a source node, which is the node of two generations earlier than the self-node. The “parent field” indicates a domain that stores information showing a source node, which is the node of one generation earlier than the self-node. In a similar way, the “child field” indicates a destination node, which is the node of one generation later than the self-node, and the “grandchild field” shows a destination node, which is the node of two generations later than the self-node.

At first, when the content of “Photo 1” is transferred from the nodeA to the nodeC (i.e. when a transfer I is executed), “nodeC” is written in the child field 11e of the propagation history information file 11 for the “Photo 1” in the node A. Then, “nodeA” is written in a parent field 12d of a propagation history information file 12 for the “Photo 1” in the nodeC.

Furthermore, when the content of “Photo 1” is transferred from the nodeC to the nodeE (i.e. when a transfer II is executed), “nodeE” is written in a child field 12e of the propagation history information file 12 for the “Photo 1” in the nodeC. After that, the nodeC notifies the nodeA that the content of “Photo 1” has been transferred from the nodeC to the nodeE. According to this notice, the nodeA writes “nodeE” in the grandchild field 11f in the propagation history information file 11 for the “Photo 1” in the nodeA.

Furthermore, when the content of “Photo 1”is also transferred from the nodeE to the nodeF (i.e. when a transfer III is executed), in a similar way as the above, the nodeC is notified from the nodeE that the content of “Photo 1”has been transferred from the nodeE to the nodeF. Based upon the notice, the nodeC writes “nodeF” in a grandchild field 12f of the propagation history information file 12 for the “Photo 1”. Moreover, when the content of “Photo 1” is transferred from the nodeE to the nodeD (i.e. when a transfer IV is executed), “nodeD” is added in the grandchild field 12f of the propagation history information file 12 for the “Photo 1” in the nodeC.

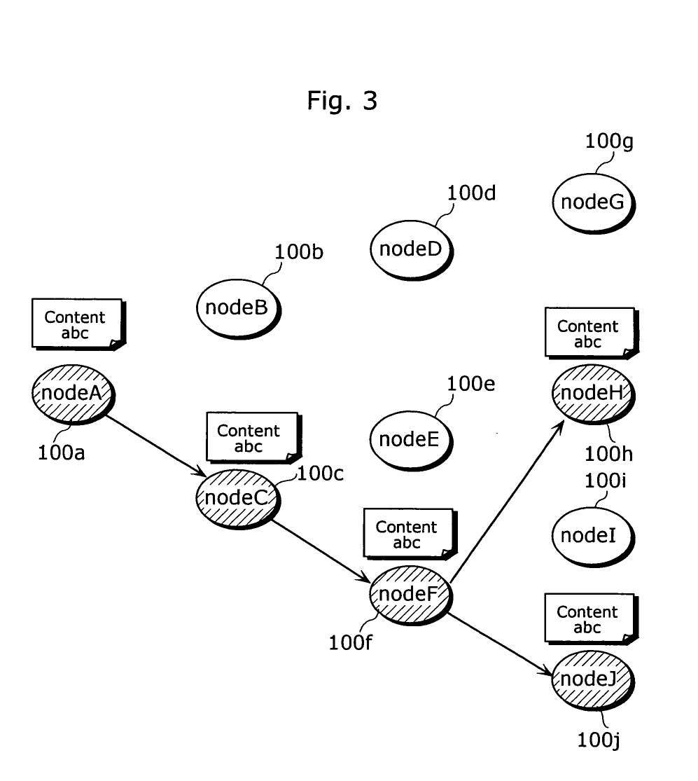

FIG. 3 shows an overview diagram to show a more generalized form of the propagation history decentralized management system 10 in the above FIG. 1. FIG. 3 (that is partially different from the above FIG. 1) shows how content having its content ID as “abc” (hereinafter referred to as “content abc”) is sequentially transferred in an order of nodeA→nodeC→nodeF→nodeH and nodeJ.

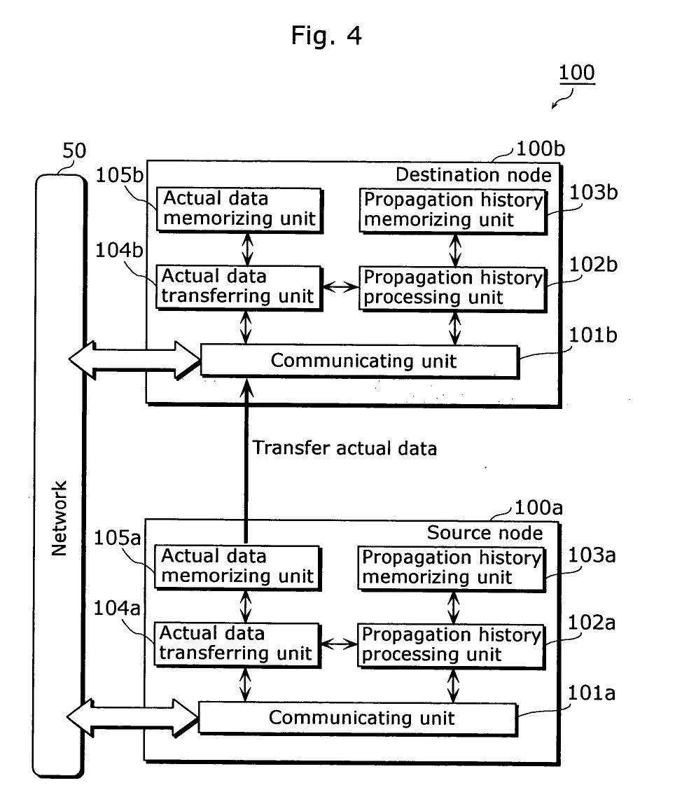

FIG. 4 is a block diagram that shows functional configurations of a source node 100a and a destination node 100b in the propagation history decentralized management system 10 according to the present embodiment. Basically, the source node 100a and the destination node 100b have the same functional configuration, and both nodes respectively have functions as the source node and the destination node.

The source node 100a is connected to a network 50, and contains the following elements: a communicating unit 101a that controls communications with other nodes; a propagation history processing unit 102a that generates and updates a propagation history information file; a propagation history memorizing unit 103a that memorizes the propagation history information file for the predetermined number of generations; an actual data transferring unit 104a that reads out content and the like from an actual data memorizing unit 105a, executes data conversion and transmits the converted data to the communicating unit 101a; and the actual data memorizing unit 105a that holds content and the like received from other node.

On the other hand, the destination node 100b contains the following elements: a communicating unit 101b; a propagation history processing unit 102b; a propagation history memorizing unit 103b; and an actual data memorizing unit 105b, which are the same as the communicating unit 101a, the propagation history processing unit 102a, the propagation history memorizing unit 103a, and the actual data memorizing unit 105a in the above source node 100a. In addition to them, the destination node 100b also contains an actual data transferring unit 104b that converts data received from the communicating unit 101b, etc., and stores content and the like in the actual data memorizing unit.

The following specifically describes functions of the propagation history processing unit 102a (or 102b) along with processes executed in the nodeC and the nodeF in the above FIG. 3. When the propagation history processing unit 102a of the nodeC receives from the communicating unit 101a a notice showing that the content “abc” has been received from the nodeA, it generates the propagation history information file for the content “abc”, and writes “abc” in a field showing the content ID and “nodeA” in a field showing a node of one generation earlier. Also, it writes “nodeC” in a field showing a node of zero generation (i.e. the self-node that stores the concerned content “abc”).

Furthermore, when the propagation history processing unit 102a of the nodeC receives from the communicating unit 101a a notice showing that the content “abc” has been transferred to the nodeF, it writes “nodeF” in a field showing the node of one generation later in the propagation history information file.

After that, when the propagation history processing unit 102a of the nodeC receives from the nodeF a notice showing that the content “abc” has been transferred from the node F to the nodeH and the nodeJ, it writes “nodeH and nodeJ ” in a field showing a node of two generations later in the propagation history information file.

On the other hand, when the propagation history processing unit 102a of the nodeF receives the content “abc” from the nodeC, in a way similar to the propagation history processing unit 102a of the above nodeC, it generates the propagation history information file for the content “abc”, and writes “abc” in a field showing the content ID, “nodeA” in a field showing the node of two generations earlier, and “nodeC” in a field showing the node of one generation earlier. Also, it writes “nodeF” in a field showing the node of the zero generation.

Furthermore, when the propagation history processing unit 102a of the nodeF receives from the communicating unit 101a a notice showing that the content “abc” has been transferred to the nodeH and the nodeJ, it writes “nodeH and nodeJ ” in the field showing the node of one generation later in the propagation history information file.

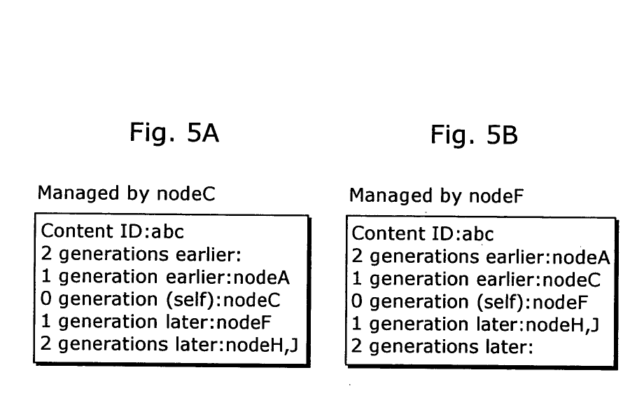

FIG. 5A and FIG. 5B are examples indicating how the propagation history information file is written in the nodeC and the nodeF after the above transfers are executed.

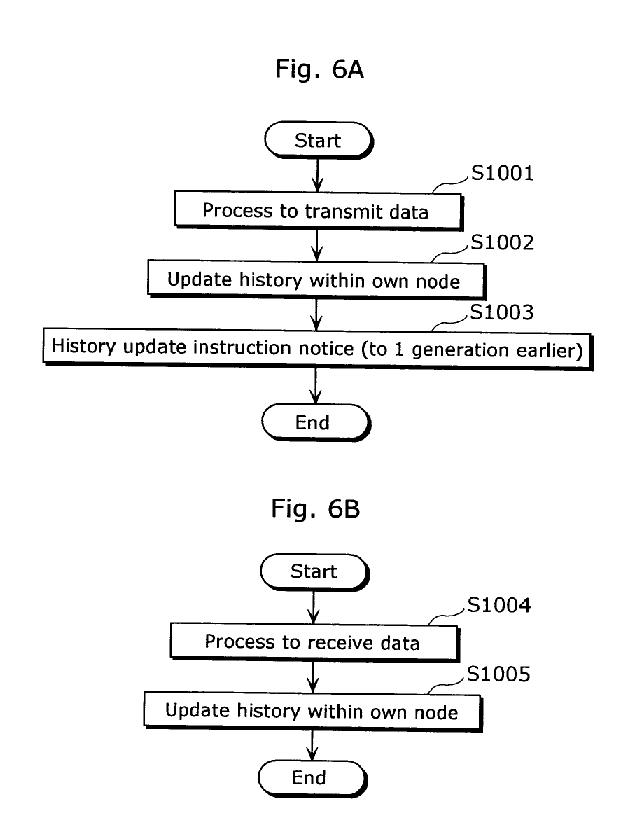

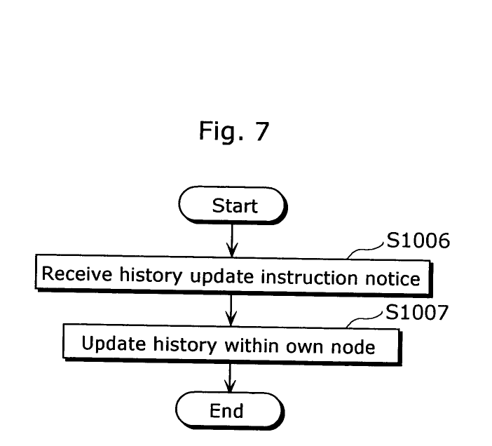

The following provides more detailed description of actions taken by the propagation history decentralized management system 10 structured as above, with reference to FIG. 6 and FIG. 7.

FIG. 6A is a flow chart to show a flow of history information updating processes for updating details (as well as generating new details) of the propagation history information file in the source node 100a for a case content and the like (for example, the content abc) are transmitted to other node.

At first, the communicating unit 101a of the source node 100a transmits content and the like, which has been read out from the actual data memorizing unit 105a by the actual data transferring unit 104a, to the destination node 100b via the network 50 (S1001).

According to this, the propagation history processing unit 102a, which has received a notice showing execution of the above transfer from the communicating unit 101a of the source node 100a, adds (or newly writes) an identifier of the destination node (for example, nodeF) in the field of the node of one generation later in the propagation history information file corresponding to the transmitted content and the like, which is memorized in the propagation history memorizing unit 103a (S1002).

In addition, the propagation history processing unit 102a transmits information, which shows at least the concerned content identifier and the concerned destination node, as a “history update instruction notice” to the node written in the field of the node of one generation earlier in the above propagation history information file (S1003).

FIG. 6B is a flow chart to show a flow of history information updating processes for updating details (as well as generating new details) of the propagation history information file in the destination node 100b for a case content and the like are received from other node.

At first, when the communicating unit 101b of the destination node 100b receives content and the like from other node, it stores the received content and the like in the actual data memorizing unit 105b via the actual data transferring unit 104b (S1004), and also instructs the propagation history processing unit 102b to add (or to newly write) an identifier of the source node in the field of the node of one generation earlier in the propagation history information file (S1005).

FIG. 7 is a flow chart to show a flow of history information updating processes in a node that receives a history update instruction notice.

At first, when the propagation history processing unit 102a of the source node 100a receives the history update instruction notice via the communicating unit 101a from the node of one generation later to which the content and the like were previously transmitted (S1006), it adds a node identifier, which is contained in the history update instruction notice, to the field of the node of two generations later in the propagation history information file for the content, which corresponds to the content identifier contained in the history update instruction notice, among the propagation history information files memorized in the propagation history memorizing unit 103a (S1007).

As has been mentioned above, since each node in the propagation history decentralized management system according to the present embodiment manages communication states based on the propagation history information for preceding two generations and subsequent two generations of the self-node in terms of propagation of content and the like within the network, it is possible to keep a data amount required for management in a certain level, and completely track a route of the content and the like that are propagated.

(Modified Embodiment)

In the above example of the present embodiment, the propagation history decentralized management system 10 is functioned based on an assumption that all of the nodes are normally operated, however, in a reality, some of the nodes may not be able to communicate because they are switched off, broken or due to something else.

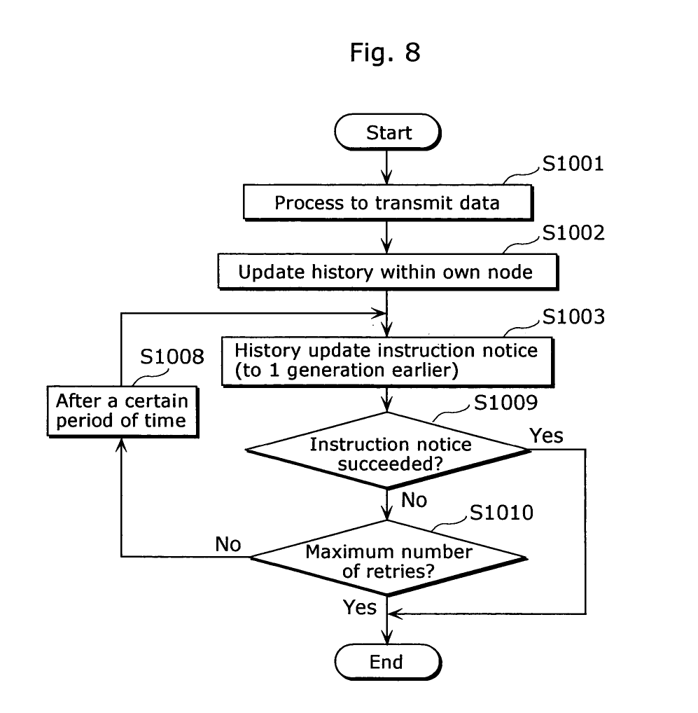

Therefore, as a modified embodiment of the first embodiment, the following describes, with reference to FIG. 4 and FIG. 8, how the propagation history information can be managed in a situation where a node, which is not available to communicate, is included within the propagation history decentralized management system. In this modified embodiment, its basic functional configuration is the same as one in the propagation history decentralized management system 10 in FIG. 4 except for the propagation history processing unit 102a of the source node 100a in FIG. 4. Therefore, differences in the functional configuration are mainly explained.

In addition to the functions of the above propagation history processing unit 102a, when the history update instruction notice is not normally completed, a propagation history processing unit 112a (and a propagation history processing unit 112b, both of the units are not shown in drawings) in this modified embodiment retries the notice a certain number of times (for example, 5 times) after a certain period of time (for example, after 10 minutes) (hereinafter referred to as a “retrying process”).

FIG. 8 is a flow chart to show a flow of history information updating processes in the source node for a case content and the like are transmitted to other node according to this modified embodiment.

At first, when the content and the like are transmitted to the destination node 100b from the source node 100a, the source node 100a transmits information, which indicates at least the concerned content identifier and the concerned destination node, to the node written in the field of the node of one generation earlier as a “history update instruction notice” in the same way as FIG. 6A of the above embodiment (S1001˜S1003).

In this case when the history update instruction notice is not normally completed due to communication disability of a communication counterpart (S1009: No), the propagation history processing unit 112a retries the history update instruction notice (S1003˜S1010) within a range of a predetermined number of retries (S1010) after a certain period of time (S1008). This attempt is repeated until either the history update instruction notice is successfully executed or the number of retries reaches its upper limit.

The processes of the node that receives the history update instruction notice are the same as those of the above embodiment.

As has been mentioned up to this point, even when the node of one generation earlier is not available to communicate at the time of the history update instruction notice, it is possible to manage the propagation history information in a more integral way by executing the retries.

(Second Embodiment)

The above explanation of the first embodiment is given based on the assumption that content is transmitted and received in the embodiments. However, this embodiment is presented based on an assumption that a discretional control command is propagated in stead of content and the like. The following describes the embodiment with reference to drawings.

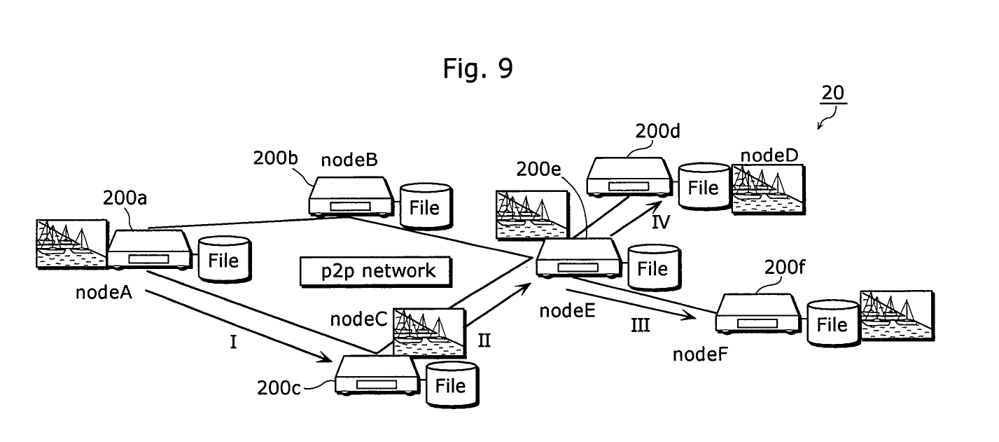

FIG. 9 is an overview diagram of a propagation history decentralized management system 20 according to the present embodiment. Points of the propagation history decentralized management system 20, which are different from the first embodiment mentioned above, is that the control command is transferred in stead of the content and the like, and that the content and the like are controlled according to the control command (for example, deletion of the content).

For instance, a user, who wants to delete specific content (i.e. a person who has certain authority, like a controller or a person who has entered the content) located in this propagation history decentralized management system 20, finds at least one node that holds the concerned content. Then, he/she transmits the node a command that sequentially deletes the specific content in the nodes written in the field of the node of one generation later in the propagation history information file. By repeating the above processes, all of the specific contents existing in this propagation history decentralized management system 20 are deleted.

When the command cannot be transmitted to the node of one generation later due to a communication failure, the command shall be transmitted to a generation after the next generation (i.e. the node of two generations later). Then, if there are any nodes that cannot receive the command, the command is retransmitted after a certain period of time.

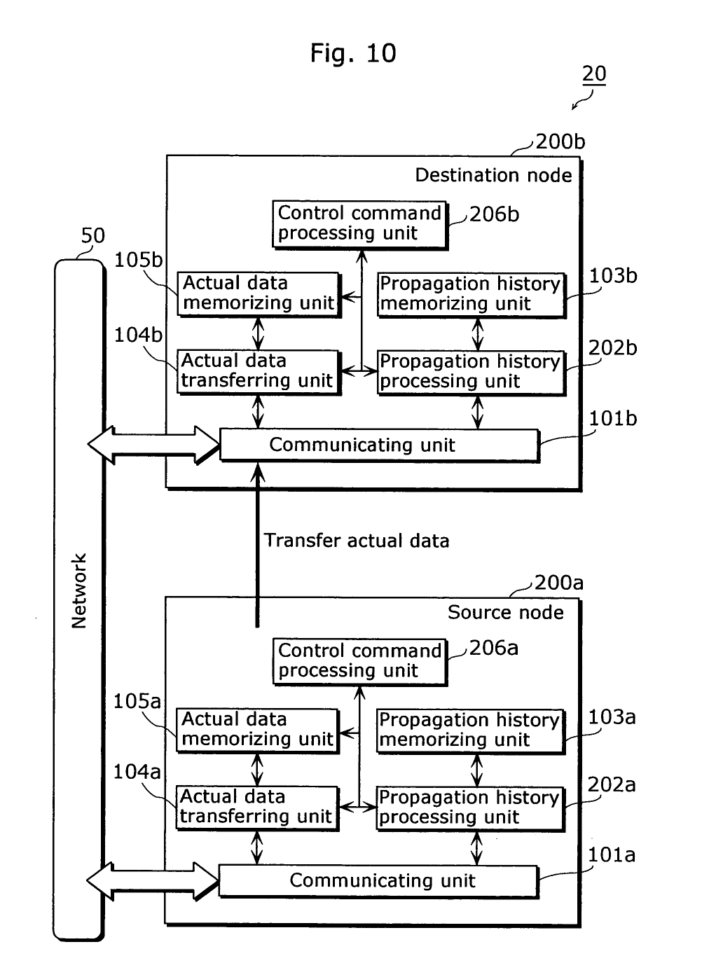

FIG. 10 is a block diagram to show functional configurations of a source node 200a and a destination node 200b in the propagation history decentralized management system 20 according to the present embodiment. As shown in FIG. 10, functional configurations of the source node 200a and the destination node 200b are the same as those of the source node 100a and the destination node 100b in the first embodiment mentioned above except for points that a control command processing unit 206a and a control command processing 206b are respectively added, and that a propagation history processing unit 202a and a propagation history processing unit 202b are respectively equipped with these nodes in stead of the propagation history processing unit 102a and the propagation history processing unit 102b. Therefore, the following mainly describes functions and actions of the control command processing unit 206a, the control command processing unit 206b, the propagation history processing unit 202a and the propagation history processing unit 202b.

The control command processing unit 206a and the control command processing unit 206b exercises controls over the content and the like (for example, deleting certain content) according to a control command received via the actual data transforming unit 104a.

In addition to a retrying process function of the propagation history processing unit 112a and the propagation history processing unit 112b in the modified embodiment of the above first embodiment, for a case that a transfer of the controlling command to a next node is not normally completed, the propagation history processing unit 202a and the propagation history processing unit 202b have a function to skip a predetermined number of node generations (e.g. two generations) and to try to transfer the controlling command to a node coming after the predetermined number of generations (hereinafter referred to as a “following process”). Furthermore, according to an instruction received from an operator, the propagation history processing unit 202a and the propagation history processing unit 202b have a function to change a value in the predetermined number of generations in the above following process, and a function to change a value in the number of generations of the propagation history information that is memorized in the said propagation history memorizing unit 103a and the propagation history memorizing 103b.

Moreover, the propagation history processing unit 202a and the propagation history processing unit 202b may have a function to memorize a state, which indicates the transfer of the controlling command is not normally completed (for example, information that shows the concerned node, i.e. the node which the transfer was failed to, is how many generations ahead and how many times the failure occurred), in the propagation history memorizing unit 103a (or the propagation history memorizing unit 103b), and to automatically change the predetermined number of generations according to the state that shows incompletion of these transfers. For example, for a case that the transfer to the node of two generations later is failed twice, the above number of generations is automatically switched from two to three.

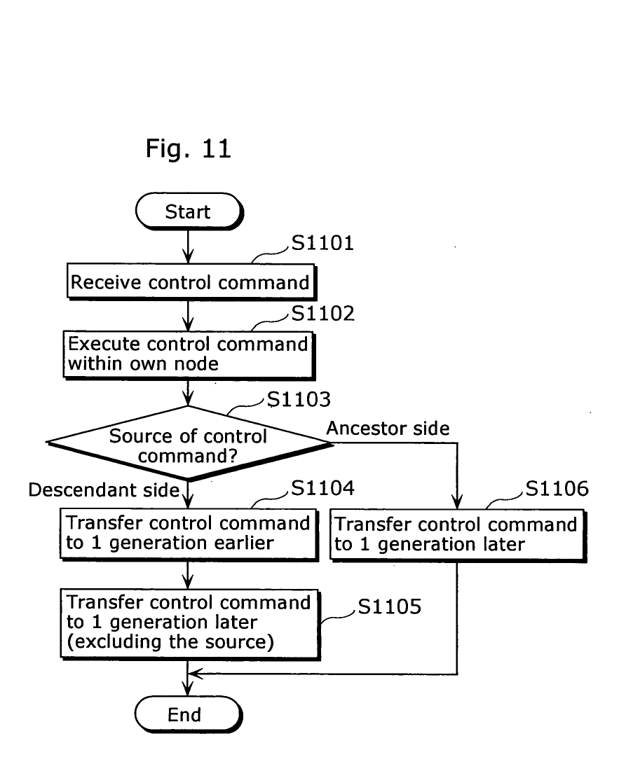

FIG. 11 is a flow chart to show a flow of processes for a case the destination node 200b receives a control command, “Delete certain content” from the source node 200a in the present embodiment.

At first, when the control command processing unit 206b receives the above control command via the actual data transferring unit 104b (S1101), it refers to the actual data memorizing unit 105b, and deletes the concerned content (S1102).

Next, the propagation history processing unit 102b refers to the propagation history information file corresponding to the concerned content, and checks the node that transmitted the above control command. When the node that transmitted the control command is at an ancestor side (S1103: at the ancestor side), it transfers the control command to a node of one generation later (at a descendant side) (S1106). On the other hand, when the node that transmitted the control command is at the descendant side (S1103:at the descendant side), it transfers the control command to a node of one generation earlier (at the ancestor side) (S1104), and moreover it transfers the control command to the node of one generation later (at the descendant side) except for the one that transmitted the control command (S1105).

As mentioned above, by having all of the nodes receiving the control command execute the same processes, the control command is executed in all of the nodes written in the propagation history information file. Therefore, it makes it possible to delete all of the concerned content in the network.

(Modified Embodiment 1)

In the same way as the modified embodiment of the first embodiment mentioned above, the following describes, as a modified embodiment of the second embodiment, how the control command is retransmitted for a case some node, which is not available to communicate, is included in the present system 20.

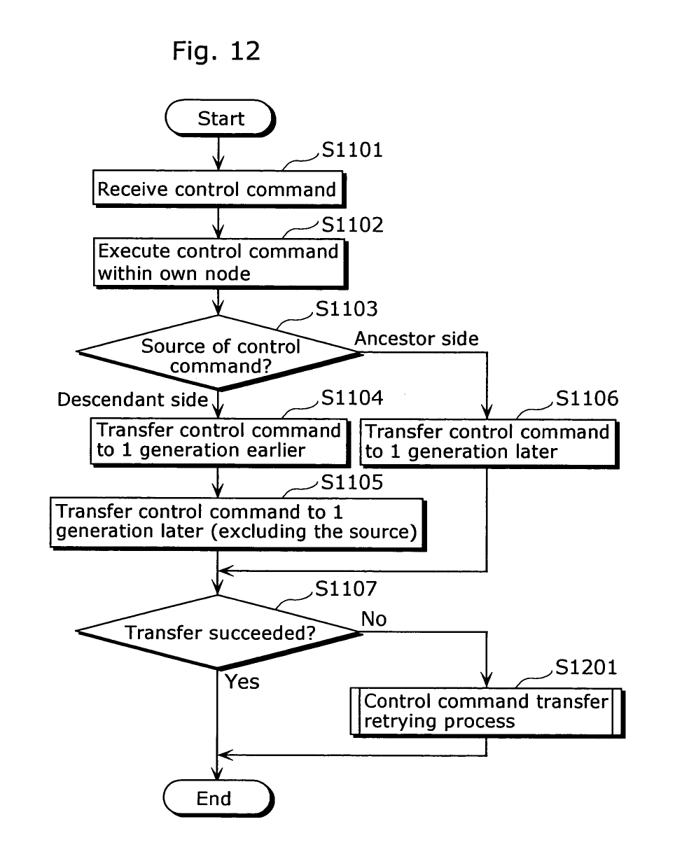

FIG. 12 is a flow chart to show a flow of processes for a case the destination node receives the control command. Explanation of parts that are the same as those in the flow chart in the above FIG. 11 is omitted.

The propagation history processing unit 102b determines whether the control command has been successfully transferred or not (S1107). When the transfer has been failed (S1107: No), it executes a control command transfer retrying process (S1201).

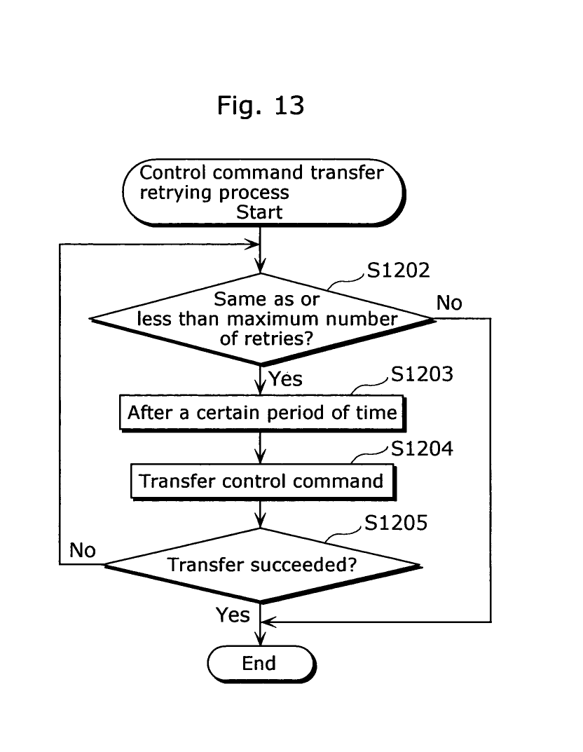

FIG. 13 is a flow chart to show a flow of the control command transfer retrying process (S1201).

When the propagation history processing unit 102b fails to transfer the control command to a node, it retransfers the control command to the same node, which the transfer is failed to (S1204), within a range of the predetermined number of retries (S1202) after a certain period of waiting time (S1203). When it fails to transfer the control command once again (S1205:No), it repeats the same process until the transfer can be successfully completed or until the number of retries reaches the predetermined number of times (S1202˜S1205).

In this case, setting an appropriate value for the waiting time increases a chance to succeed the retry, and at the same time, it decreases possibility to nullify the transfer of the control command in a middle way of course.

(Modified Embodiment 2)

The following modified embodiment is a further improved form of the above mentioned modified embodiment 1. When the control command is failed to be transferred to a node, the control command is transferred to a subsequent node of the node which the transfer is failed to.

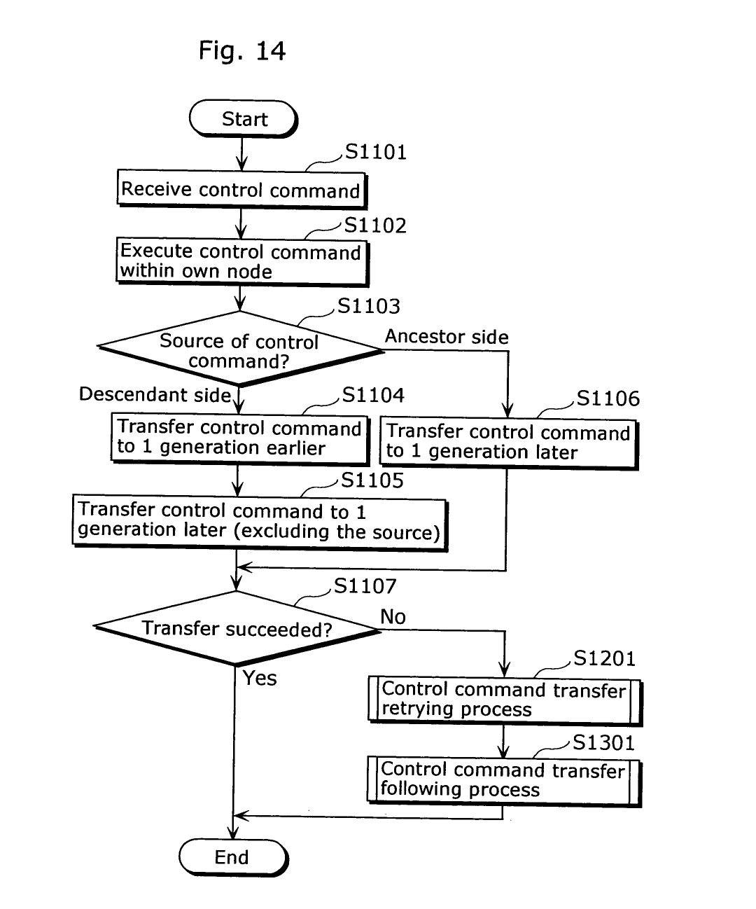

FIG. 14 is a flow chart to show a flow of processes for a case the destination node receives the control command. Explanations of parts that are the same as those in the above FIG. 12 are omitted.

When the propagation history processing unit 102b fails to execute the control command transfer retrying process (S1201), it executes a control command transfer following process (S1301).

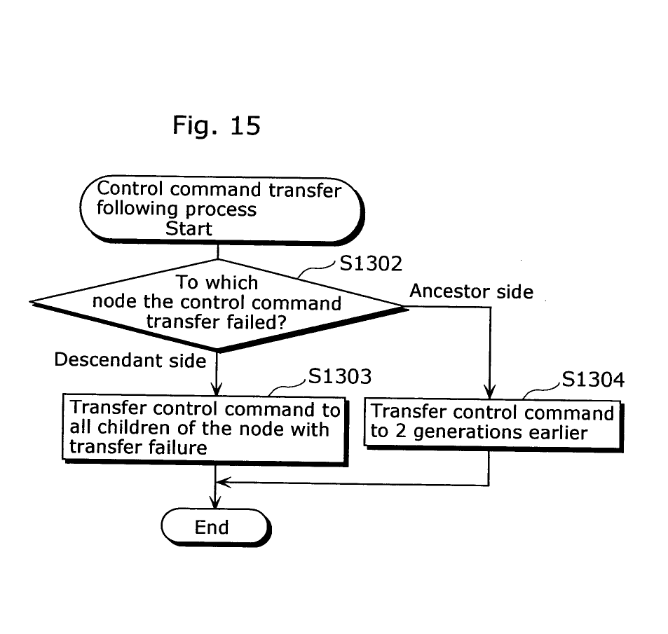

FIG. 15 is a flow chart to show a flow of the control command transfer following process (S1301).

When the propagation history processing unit 102b fails to transfer the control command to a node, it determines which node the transfer of the control command is failed to. When the node is at the ancestor side (S1302:at the ancestor side), it refers to the propagation history information file once again, transfers the control command to the node of two generations earlier (i.e. the node regarded to be a grandparent), and completes the control command transfer following process (S1304).

On the other hand, when the node which the transfer is failed to is at a descendant side (S1302: at the descendant side), it refers to the propagation history information file once again, transfers the control command to all of the node of one generation later than the node which the transfer is failed to (i.e. the node regarded to be a grandchild), and completes the control command transfer following process (S1303).

(Third Embodiment)

The present embodiment describes a propagation history decentralized management system 30 that can execute remote maintenance for home electric appliances connected to a network, with reference to drawings.

In general, a home electric appliance that is connectable to a network has an IP address prescribed and assigned by its manufacturer. The manufacturer of the home electric appliance can construct its own home electric appliance network through mobile IP technology (such as RFC2002) and pier-to-pier network technology without requiring a general user to do any setups.

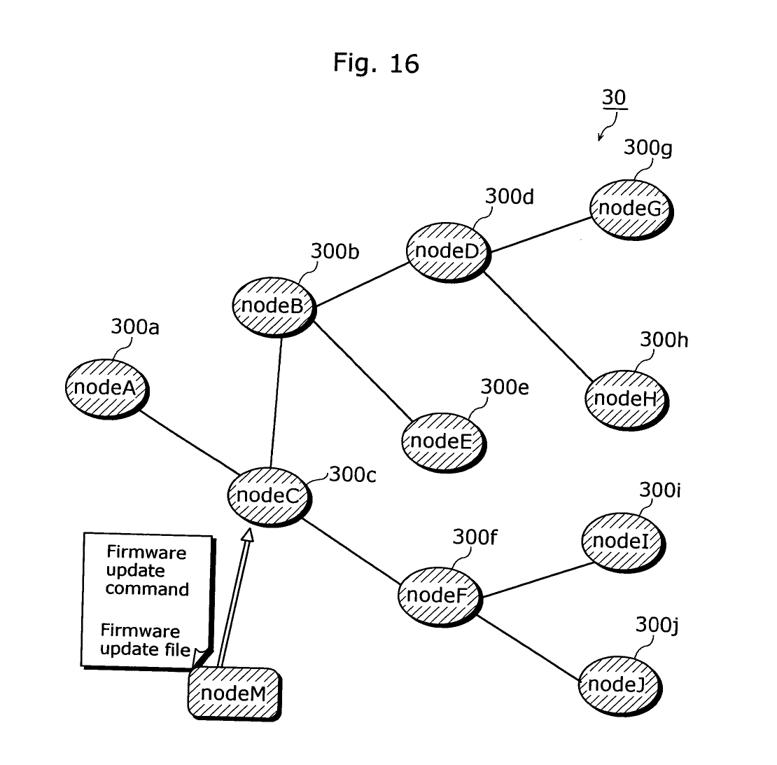

FIG. 16 is a conceptual diagram of the propagation history decentralized management system 30 structured by the home electric appliances. In FIG. 16, a nodeM represents a manufacturer's node that dispatches information, and a nodeA˜a nodeJ are net home electric appliances that form a network of tree structure through the pier-to-pier network technology.

When the manufacturer updates a firmware of the home electric appliances, the firmware, which is desired to be updated, is transmitted from the nodeM to, for example, the nodeC. The firmware transmitted is propagated into all of the nodes in the manufacturer's home electric appliance network through the nodes forming the pier-to-pier network that is pre-constructed.

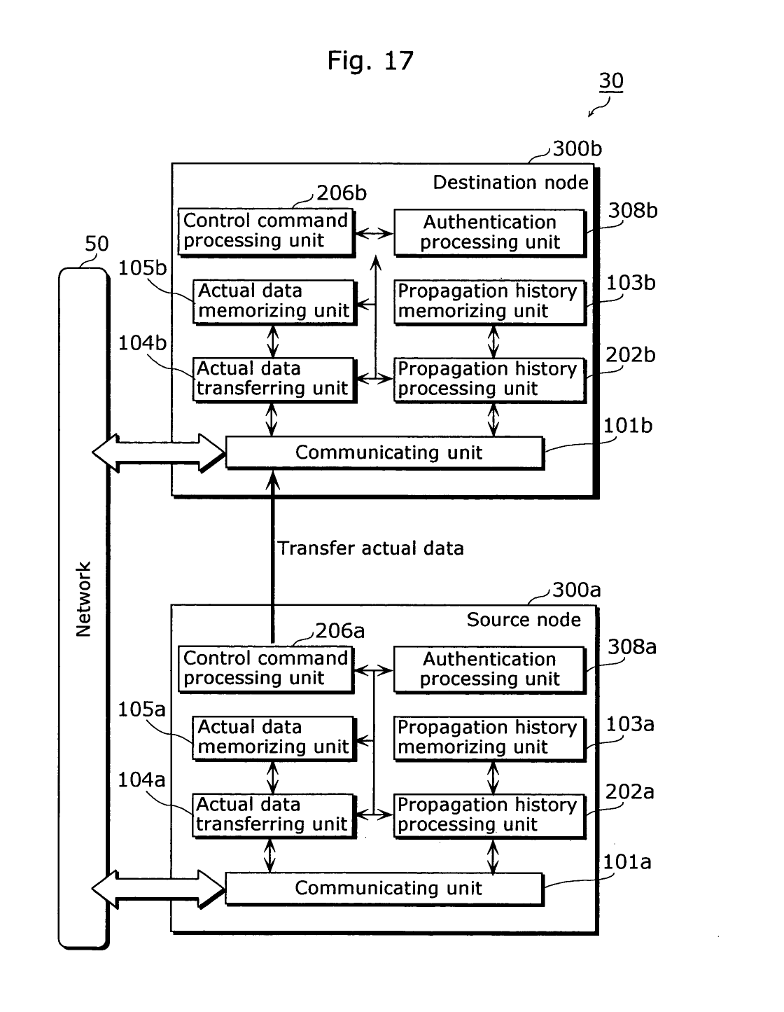

FIG. 17 is a block diagram to show functional configurations of a source node 300a and a destination node 300b in the propagation history decentralized management system 30 according to the present embodiment. As shown in FIG. 17, when the source node 300a and the destination node 300b are compared with the source node 200a and the destination node 200b in the second embodiment mentioned above, a difference is that the source node 300a and the destination node 300b are respectively equipped with an authentication processing unit 308a and an authentication processing unit 308b.

The authentication processing unit 308a and the authentication processing unit 308b confirm validity of the control command. For example, using a mechanism of PKI(Public Key Infrastructure), they authenticate a node that originates the information, or check validity of the control command transmitted from the node that has been confirmed to be reliable.

Next, actions of the propagation history decentralized management system 30 structured as above are explained.

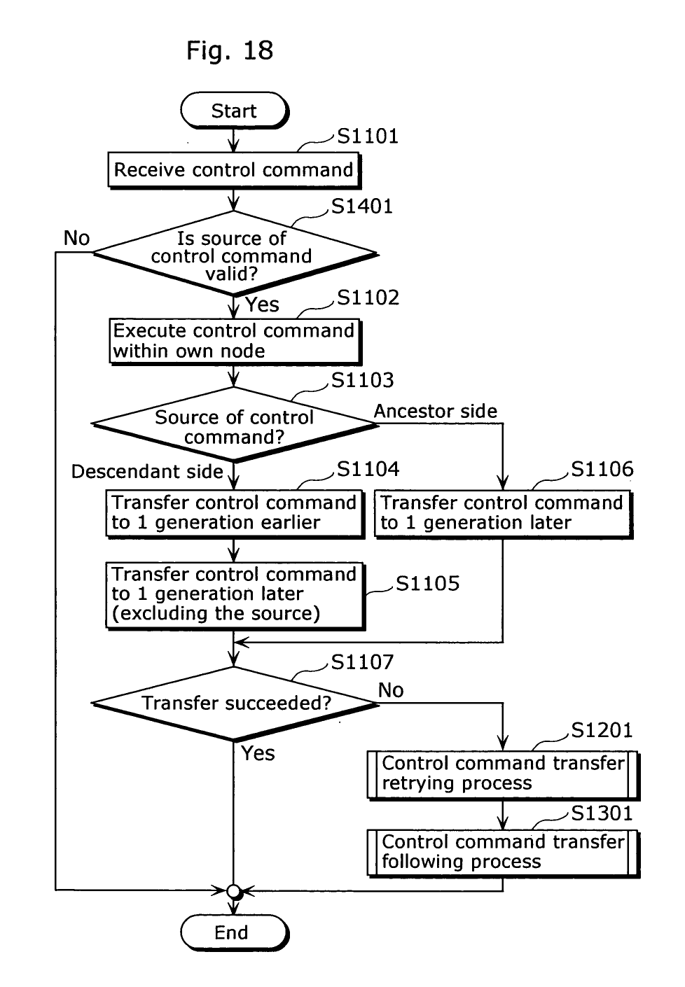

FIG. 18 is a flow chart to show a flow of processes in the propagation history decentralized management system 30. Explanations of parts in the flow chart in FIG. 18, which are the same as those of the flow chart in FIG. 14 according to the second embodiment, are omitted.

At first, when a control command processing unit 206b of the destination node 300b receives a “firmware update file” and a “command to distribute and install a specific file to all nodes” as a control command that are received from other node (S1101), it confirms validity of the concerned control command or validity of the node that has transmitted the concerned control command (S1401). When the validity is not confirmed (S1401: No), it judges that the control command is iniquity, and ends the process without executing the control command.

When the validity of the above control command is confirmed (S1401: Yes), the actual data transferring unit 104b installs the update file. Additionally, the propagation history processing unit 102b refers to link information of the pier-to-pier network, and transfers the “firmware update file” and the “command to distribute and install the specific file to all nodes” (S1102).

Next, when the node, which transmitted the control command, is at the ancestor side of the tree structure (S1103: at the ancestor side), it transfers the control command to the node of one generation later (at the descendant side) (S1106). When the node, which transmitted the control command, is at the descendant side of tree structure (S1103:at the descendant side), it transfers the control command to the node of one generation earlier (at the ancestor side) (S1104), and additionally transfers the control command to the node of one generation later (at the descendant side)except for the node that transmitted the control command (S1105).

At this point, when there the destination node does not exist in the network due to a situation such as power shut down or the like, and the transfer of the control command is failed (S1107: No), the control command transfer retrying process (S1201) and the control command transfer following process (S1301) are executed. The control command transfer retrying process (S1201) and the control command transfer following process (S1301) are the same processes as those in the second embodiment, their explanations are omitted here.

The present invention may be applicable to other network home electric appliances having an objective to share a file and the like. The present invention may also be applied to maintenance and the like for CDN (Contents Delivery Network).

What is claimed is:

1. A communication terminal that communicates with a plural number of other communication terminals in a network, comprising:
a data transmitting unit operable to transmit data to a first communication terminal;
a history information memorizing unit operable to memorize, per data for transmission, information which includes information specifying the first communication terminal as propagation history information that shows a propagation route of the concerned data;
a propagation information receiving unit operable to receive, from the first communication terminal, propagation information that shows that data for transmission is transmitted from the first communication terminal to a second communication terminal; and
a history information updating unit operable to add the received propagation information to corresponding propagation history information memorized in the history information memorizing unit.

2. The communication terminal according to claim 1, further comprising:
a data receiving unit operable to receive data from a third communication terminal;
an additionally memorizing unit operable to additionally memorize information, which includes information specifying the third communication terminal, in the history information memorizing unit per data for receipt, as propagation history information that shows a propagation route of the concerned data;
a second history information updating unit operable to update, when data for receipt is transmitted to a fourth communication terminal from the concerned communication terminal, the propagation history information, which is additionally memorized in the history information memorizing unit, by using information specifying the fourth communication terminal; and
a propagation information transmitting unit operable to transmit propagation information, which shows the said data is transmitted to the forth communication terminal, to the third communication terminal.

3. The communication terminal according to claim 2, further comprising:
a numerical value accepting unit operable to accept a numerical value from a user; and
a generation number restricting unit operable to restrict the number of generations of the propagation route in the history information memorizing unit based on the accepted numerical value.

4. The communication terminal according to claim 2, further comprising:
a transmission determining unit operable to determine whether the propagation information, which shows the said data is transmitted to the fourth communication terminal, is correctly transmitted to the third communication terminal or not; and
a retransmitting unit operable to try the transmission of the propagation information to the third communication terminal again when the propagation information is determined not to be correctly transmitted.

5. The communication terminal according to claim 4, further comprising:
a terminal specifying unit operable to specify a communication terminal which has received the data before said third communication terminal receives said data when the propagation information is determined not to be correctly transmitted to the third communication terminal; and
a second propagation information transmitting unit operable to transmit the propagation information, which shows the said data is transmitted to the fourth communication terminal, to the specified communication terminal.

6. The communication terminal according to claim 2, further comprising:
an authenticating unit operable to authenticate the data, which is received from the third communication terminal, and the third communication terminal,
wherein the additionally memorizing unit execute the additional memorization only when the said data and the third communication terminal are authenticated.

7. A communication terminal that communicates with a plural number of other communication terminals in a network, comprising:
a data receiving unit operable to receive data from a first communication terminal;
a history information memorizing unit operable to memorize information, which includes information specifying the first communication terminal, per data for receipt, as propagation history information that shows a propagation route of the concerned data;
a history information updating unit operable to update, when data for receipt is transmitted to a second communication terminal from the concerned communication terminal, the propagation history information, which is memorized in the history information memorizing unit, by using information specifying the second communication terminal; and
a propagation information transmitting unit operable to transmit propagation information, which shows data for transmission is transmitted to the second communication terminal, to the first communication terminal.

8. A communication system comprising at least three communication terminals connected to a network,
wherein a first communication terminal includes:
a first data transmitting unit operable to transmit data to a second communication terminal;
a first history information memorizing unit operable to memorize information, which includes information specifying the second communication terminal, per data for transmission, as propagation history information that shows a propagation route of the concerned data;
a first propagation information receiving unit operable to receive propagation information that shows data for transmission is transmitted from the second communication terminal to a third communication terminal; and
a first history information updating unit operable to add the received propagation information to the propagation history information memorized in the first history information memorizing unit,
the second communication terminal includes:
a second data receiving unit operable to receive data from the first communication terminal;
a second history information memorizing unit operable to memorize information, which includes information specifying the first communication terminal per data for receipt, as propagation history information that shows a propagation route of the concerned data;
a second history information updating unit operable to update, when data for receipt is transmitted to the third communication terminal from the concerned communication terminal, the propagation history information, which is memorized in the second history information memorizing unit, by using information specifying the third communication terminal; and
a second propagation information transmitting unit operable to transmit propagation information, which shows data for transmission is transmitted to the third communication terminal, to the first communication terminal.

9. A communication method for communicating with a plural number of other communication terminals in a network, comprising:
a data transmitting step of transmitting data to a first communication terminal;
a history information memorizing step of memorizing information, which includes information specifying the first communication terminal in a specific memorizing unit, per data for transmission, as propagation history information that shows a propagation route of the concerned data;
a propagation information receiving step of receiving, from the first communication terminal, propagation information that shows data for transmission is transmitted from the first communication terminal to a second communication terminal; and
a history information updating step of adding the received propagation information to corresponding propagation history information memorized in the memorizing unit.

10. The communication method according to claim 9, further including:
a data receiving step of receiving data from a third communication terminal;
an additionally memorizing step of additionally memorizing information, which includes information specifying the third communication terminal, in the memorizing unit per data for receipt, as propagation history information that shows a propagation route of the concerned data;
a second history information updating step of updating, when data for receipt is transmitted to a fourth communication terminal from the concerned communication terminal, the propagation history information, which is additionally memorized by the additionally memorizing step, by using information specifying the fourth communication terminal; and
a propagation information transmitting step of transmitting propagation information, which shows the said data is transmitted to the forth communication terminal, to the third communication terminal.

11. A communication method for communicating with a plural number of other communication terminals in a network, comprising:
a data receiving step of receiving data from a first communication terminal;
a history information memorizing step of memorizing information, which includes information specifying the first communication terminal, in a specific memorizing unit per data for receipt, as propagation history information that shows a propagation route of the concerned data;
a history information updating step of updating, when data for receipt is transmitted to a second communication terminal from the concerned communication terminal, the propagation history information, which is memorized in the memorizing unit, by using information specifying the second communication terminal; and
a propagation information transmitting step of transmitting propagation information, which shows data for transmission is transmitted to the second communication terminal, to the first communication terminal.

12. A program for a communication terminal that communicates with a plural number of other communication terminals in a network, comprising:
a data transmitting step of transmitting data to a first communication terminal;
a history information memorizing step of memorizing information, which includes information specifying the first communication terminal, in a specific memorizing unit per data for transmission, as propagation history information that shows a propagation route of the concerned data;
a propagation information receiving step of receiving, from the first communication terminal, propagation information that shows data for transmission is transmitted from the first communication terminal to a second communication terminal; and
a history information updating step of adding the received propagation information to corresponding propagation history information memorized in the memorizing unit.

13. The program according to claim 12, further comprising:
a data receiving step of receiving data from a third communication terminal;
an additionally memorizing step of additionally memorizing information, which includes information specifying the third communication terminal, in the memorizing unit per data for receipt, as propagation history information that shows a propagation route of the concerned data;
a second history information updating step of updating, when data for receipt is transmitted to a fourth communication terminal from the concerned communication terminal, the propagation history information, which is additionally memorized in the additionally memorizing unit, by using information specifying the fourth communication terminal; and
a propagation information transmitting step of transmitting propagation information, which shows the said data is transmitted to the forth communication terminal, to the third communication terminal.

14. A program for a communication terminal that communicates with a plural number of other communication terminals in a network, comprising:
a data receiving step of receiving data from a first communication terminal;
a history information memorizing step of memorizing information, which includes information specifying the first communication terminal, in a specific memorizing unit per data for receipt, as propagation history information that shows a propagation route of the concerned data;
a history information updating step of updating, when data for receipt is transmitted to a second communication terminal from the concerned communication terminal, the propagation history information, which is memorized in the memorizing unit, by using information specifying the second communication terminal; and
a propagation information transmitting step of transmitting propagation information, which shows data for transmission is transmitted to the second communication terminal, to the first communication terminal.
